(19) United States
(12) Patent Application Publication
(10) Pub. No.: US 2007/0079160 A1
(43) Pub. Date: Apr. 5, 2007

(54) Controller and method of controlling multiprocessor

(75) Inventor: Kenichi Douniwa, Asaka-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/520,466

(22) Filed: Sep. 12, 2006

(30) Foreign Application Priority Data
Sep. 30, 2005 (JP) 2005-288003

(51) Int. Cl. G06F 1/00

(52) U.S. Cl. 713/322

(57) ABSTRACT

According to one embodiment, there is provided a controller for use in a multiprocessor incorporating a plurality of processors on one chip. The controller includes a communication section to perform communication with the plurality of processors, and a control section to perform control of switching operation states of the plurality processors one by one at every specified time via the communication section.

### CROSS-REFERENCE TO RELATED APPLICATIONS

This application is based upon and claims the benefit of priority from Japanese Patent Application No. 2005-288003, filed Sep. 30, 2005, the entire contents of which are incorporated herein by reference.

### BACKGROUND

1. Field

One embodiment of the invention relates to a controller for use in a multiprocessor incorporating a plurality of processors formed on one chip, and a method of controlling a multiprocessor.

2. Description of the Related Art

Some types of information processing apparatus, such as personal computers, use a multiprocessor incorporating a plurality of processors formed on one chip.

In a multiprocessor, only a specific processor may be heated to a particularly high temperature due to a difference in heat generation depending on a difference in program operated by the processors, a difference in heat radiation between the processors, etc. Owing to the heat generation only in a specific processor at a particularly high temperature, the multiprocessor may malfunction.

To avoid such situations, the multiprocessor generally requires a cooling mechanism of a higher power as compared to a case where no specific processor is locally heated. In addition, the mount area or volume required for the cooling mechanism is inevitably large.

Jpn. Pat. Appln. KOKAI Publication No. 2004-240669 (paragraph 0025 etc.) discloses a technique of avoiding heat from concentrating into a specific part of a chip on which a plurality of processors are mounted. According to the technique disclosed in this publication, temperature information on a processor relating to power consumption for a job process is estimated and the job is assigned to a free processor based on the estimation result.

However, the temperature estimated by the conventional art disclosed in the above publication does not necessarily coincide with the actual temperature, and there may be an undesirable influence due to an error in temperature. Further, in the above conventional art, special calculating means is additionally required for performing the estimation, resulting in an increase in cost.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a configuration of a system including a multiprocessor according to a first embodiment of the present invention;

FIG. 2 is an exemplary diagram for explaining operations of the respective processors in the case where a first control mode is applied;

FIG. 3 is an exemplary diagram for explaining temperatures of the respective processors in the case where the first control mode is applied;

FIG. 4 an exemplary diagram for explaining operations of the respective processors in the case where a second control mode is applied;

FIG. 5 an exemplary diagram for explaining operations of the respective processors in the case where a third control mode is applied;

FIG. 6 is an exemplary flowchart showing operations of a controller of the first embodiment;

FIG. 7 is an exemplary block diagram showing a configuration of a system including a multiprocessor according to a second embodiment of the present invention; and

FIG. 8 is an exemplary flowchart showing operations of a controller of the second embodiment.

### DETAILED DESCRIPTION

Various embodiments according to the invention will be described hereinafter with reference to the accompanying drawings. In general, according to one embodiment of the invention, there is provided a controller for use in a multiprocessor incorporating a plurality of processors on one chip. The controller includes a communication section to perform communication with the plurality of processors, and a control section to perform control of switching operation states of the plurality processors one by one at every specified time via the communication section.

### First Embodiment

First, a first embodiment of the present invention will be described.

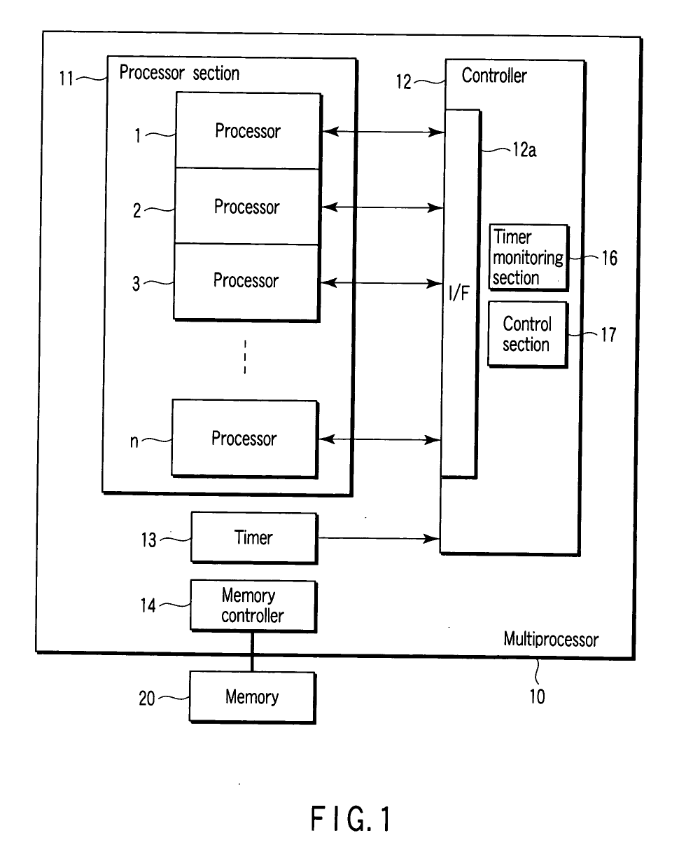

FIG. 1 is a block diagram showing a configuration of a system including a multiprocessor according to a first embodiment of the present invention.

A multiprocessor 10 and a memory 20 shown in FIG. 1 are mounted in, for example, a personal computer. The multiprocessor 10 incorporates a plurality of processors formed on a chip. It includes a processor section 11, a controller 12, a timer 13 and a memory controller 14. The memory 20 is a main memory which the multiprocessor 10 uses and is a connected to the memory controller 14 in the multiprocessor 10.

The processor section 11 has a plurality of processors 1, 2, 3, . . . , n. Each of the processors is, for example, a central processing unit (CPU), which executes programs loaded in the memory 20. The controller 12 includes an interface section (I/F) 12a, a timer monitoring section 16 and a control section 17.

The interface section 12a has a communication function for performing a process of interfacing between the controller 12 and the processors 1, 2, 3, . . . , n.

The timer monitoring section 16 monitors whether a specified time has elapsed on the basis of elapsed time information obtained from the timer 13.

The control section 17 performs control of sequentially switching operation states of the processors one by one at every specified time via the interface section 12a. Especially, the control section 17 controls the processors consecutively at every specified time so that the amount of heat generated from one processor is less than the amount of heat generated from any other processor. More specifically, the control section 17 has the following control modes M1 to M3 as functions to prevent heat from concentrating into a specific part of the processor section 11.

When the first control mode M1 is applied, the control section 17 performs control of stopping the processors one by one at every specified time.

When the second control mode M2 is applied, the control section 17 performs control of lowering the operation frequencies of the processors one by one to a value lower than those of the other processors at every specified time.

When the third control mode M3 is applied, the control section 17 performs control of setting the processors one by one at every specified time to execute a program having a load that is lower than those of the programs executed by the other processors.

The control section 17 applies any of the above control modes M1 to M3 suitably depending on the conditions, so that the heat generated in the chip can be uniform. The control prevents the processors from malfunctioning or breaking down due to heat.

As a modification, two or three of the above control modes M1 to M3 may be combined into one control mode. Alternatively, any one of the control modes M1 to M3 may be performed fixedly, or selectively depending on operation conditions.

FIG. 1 shows an example, in which the controller 12 is incorporated as hardware in the one-chip multiprocessor 10. However, the present invention is not limited to this configuration. For example, the controller 12 may be implemented as software (program) that is executed under the operating system (OS) loaded in the memory 20. In this case, the personal computer may be configured such that the modes M1 to M3 can be selected by the user via a setting screen. The controller 12 implemented as software is advantageous in that a new control mode can be added or an existing control mode can be changed easily by updating the program.

The timer 13 measures elapsed time. Elapsed time information obtained by the timer 13 is transmitted to the controller 12.

The memory controller 14 controls the memory 20. The memory controller 14 may be provided outside the multiprocessor 10.

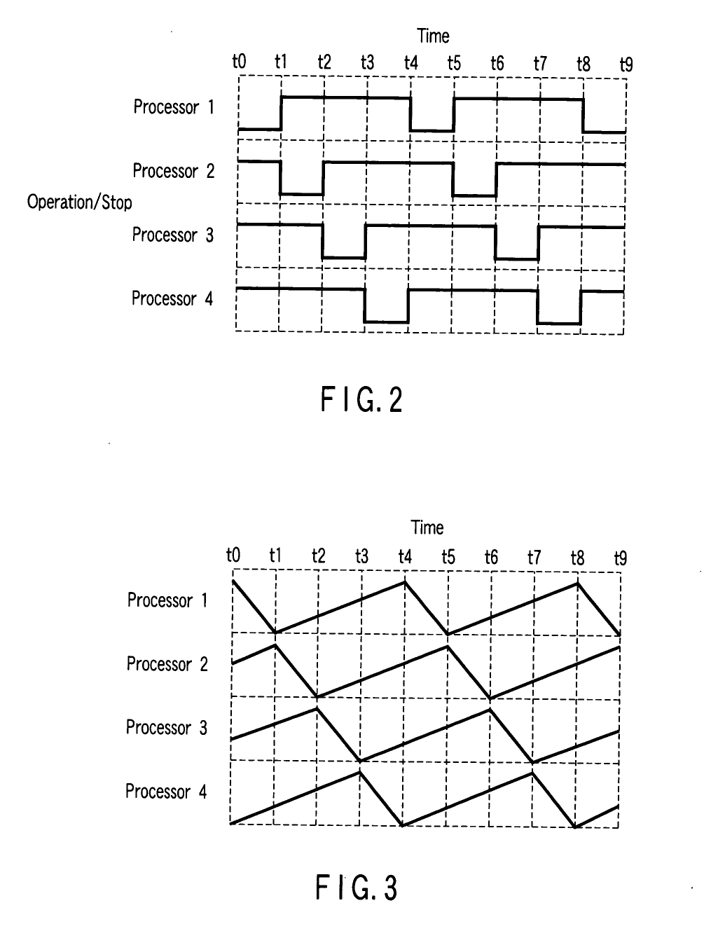

Operations of the processors 1 to 4, in the case where the control mode M1 is applied, will now be described with reference to FIG. 2. In this description, it is assumed that the number of the processors 1, 2, 3, . . . , n is four (n=4).

In the control mode M1, for example, at time t0, the control section 17 stops the processor 1, and activates the processors 2, 3 and 4. At time t1, the control section 17 stops the processor 2, and activates the processors 3, 4 and 1. At time t2, the control section 17 stops the processor 3, and activates the processors 4, 1 and 2. At time t3, the control section 17 stops the processor 4, and activates the processors 1, 2 and 3. Then, the above operation is repeated.

With the above operation, as shown in FIG. 3, when a processor is active, the temperature thereof increases. However, when the processor is stopped, it consumes less power than that in the operation time. Therefore, it generates less heat, and accordingly the temperature thereof is lowered. As a result, heat generation in a specific part of the multiprocessor can be prevented, while at least three processors are kept operating.

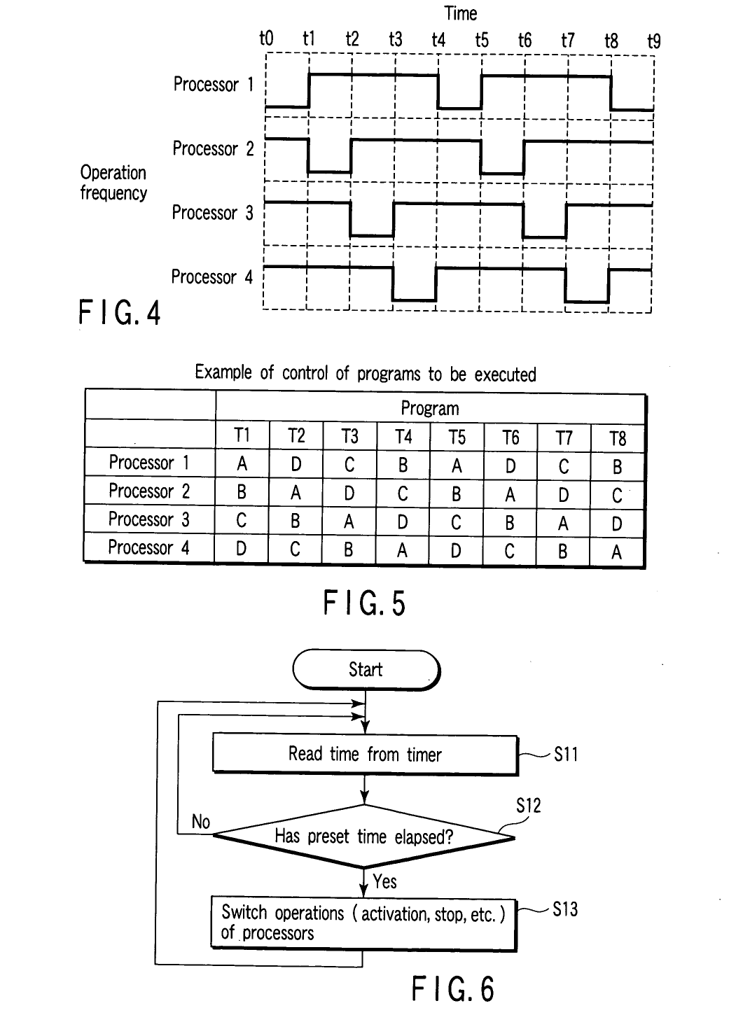

Operations of the processors 1 to 4, in the case where the control mode M2 is applied, will now be described with reference to FIG. 4.

In the above control mode M1, the operation of a processor is stopped at every specified time. However, to prevent heat generation in a specific part, the operation of a processor may not be necessarily stopped but an operation frequency thereof may be lowered.

More specifically, in the control mode M2, for example, at the time t0, the control section 17 lowers the operation frequency of the processor 1, and operates the processors 2, 3 and 4 at a high operation frequency. At the time t1, the control section 17 lowers the operation frequency of the processor 2, and operates the processors 3, 4 and 1 at a high operation frequency. At the time t2, the control section 17 lowers the operation frequency of the processor 3, and operates the processors 4, 1 and 2 at a high operation frequency. At the time t3, the control section 17 lowers the operation frequency of the processor 4, and operates the processors 1, 2 and 3 at a high operation frequency. Then, the above operation is repeated.

With the above operation, when a processor is operated at a high frequency, the temperature thereof increases. On the other hand, when the processor is operated at a low frequency, it consumes less power and generates less heat as compared to the case where it is operated at the high frequency. Accordingly, the temperature of the processor is lowered. As a result, heat generation in a specific part of the multiprocessor can be prevented, while all of the four processors are kept operating.

Operations of the processors 1 to 4, in the case where the control mode M3 is applied, will now be described with reference to FIG. 5.

The amount of heat generated by each processor varies also depending on the program executed. For example, one program may generate a large amount of heat and form a hot spot (a spot where the temperature is particularly high), whereas another program may generate less power and may not easily from a hot spot. Therefore, generation of a hot spot can be prevented by changing the programs respectively executed by the processors 1 to 4 in a predetermined order at every specified time.

For example, a case is considered, in which the four processors 1, 2, 3 and 4 respectively execute programs A, B, C and D. It is assumed that the programs B, C and D generate relatively large amounts of heat during execution, while the program A generates a relatively small amount of heat.

In this case, for example, at time T1, the control section 17 causes the processor 1 to execute the program A, the processor 2 to execute the program B, the processor 3 to execute the program C and the processor 4 to execute the program D. At time T2, the control section 17 causes the processor 1 to execute the program D, the processor 2 to execute the program A, the processor 3 to execute the program B and the processor 4 to execute the program C. Then, at time T3, the control section 17 causes the processor 1 to execute the program C, the processor 2 to execute the program D, the processor 3 to execute the program A and the processor 4 to execute the program B. At time T4, the control section 17 causes the processor 1 to execute the program B, the processor 2 to execute the program C, the processor 3 to execute the program D and the processor 4 to execute the program A. Then, the above operation is repeated.

With the above operation, when a processor executes the program B, C or D, the temperature thereof rises. On the other hand, when the processor executes the program A, the temperature thereof lowers. In the control mode M3, therefore, heat generation in a specific part of the multiprocessor can be prevented, while all of the four processors are kept operating. In the control modes M1 and M2 described above, the performance of the multiprocessor slightly lowers, because the processors are stopped one by one or the operation frequencies thereof are lowered one by one. In contrast, in the control mode M3, only the programs executed by the respective processors change and the multiprocessor as a whole normally executes all the programs A, B, C and D. Thus, the control mode M3 is advantageous in that the performance of the multiprocessor does not lower.

Next, an operation of the controller 12 of this embodiment will be described with reference to the flowchart shown in FIG. 6.

In the following description, it is assumed that the processors 1, 2, 3, . . . , n are respectively executing given programs, and the control mode M1, M2 or M3 is applied to the controller 12.

The controller 12 successively repeats reading of elapsed time information obtained from the timer 13, and determines whether a specified time (preset time) has elapsed or not (blocks S11 and S12).

If it is determined that the specified time has elapsed, the switching control (activation, stop or the like) of each processor is executed (block S13). After completion of the switching control, the process from blocks S11 to 13 is repeated.

In the block S13, if the control mode M1 is applied, the controller 12 performs control to stop operating the subject processor for a specified period of time. If the control mode M2 is applied, the controller 12 performs control to set the operation frequency of the subject processor to be lower than those of the other processors for the specified period of time. If the control mode M3 is applied, the controller 12 performs control to cause the subject processor to execute a program having a load that is lower than those of the programs executed by the other processors for the specified period of time.

As described above, according to the first embodiment, one of the control modes M1 to M3 is suitably selected and applied depending on the conditions, so that the heat generated in the chip can be uniform. The control prevents the processors from malfunctioning or breaking down due to heat.

### Second Embodiment

A second embodiment of the present invention will be described.

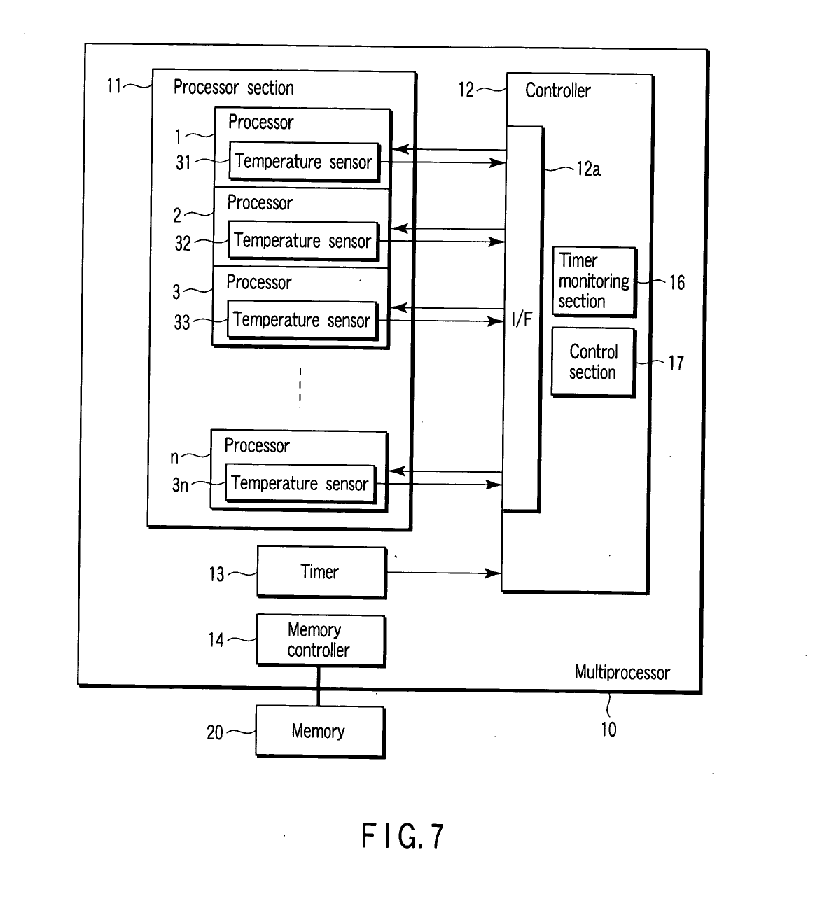

FIG. 7 is a block diagram showing a configuration of a system including a multiprocessor according to a second embodiment of the present invention. In FIG. 7, the same elements as those shown in FIG. 1 are identified by the same reference numerals as those used in FIG. 1. In the following description, the parts different from those of the first embodiment will be described.

In the second embodiment, a plurality of processors 1, 2, 3, . . . , n respectively have temperature sensors 31, 32, 33, . . . , 3n. Each of the temperature sensors detects the temperature of the corresponding processor, and transmits information indicative of the value of the detected temperature to the controller 12. The temperature sensors may be configured to transmit information indicative of an alarm or a notice of danger to the controller 12, if the detected temperature reaches a predetermined value (preset threshold value). Further, two or more predetermined values may be set as threshold values depending on the degree of temperature (for example, two threshold values may be set for an alarm and a notice of danger), and information corresponding to the degree of danger may be transmitted to the controller 12.

Moreover, in the second embodiment, the control section 17 has a function of monitoring the temperatures detected by the temperature sensors (or the degree of danger, etc.) based on the information transmitted from the temperature sensors 31, 32, 33, . . . , 3n. Thus, the control section 17 performs control of switching the operation state of any of the processors at every specified time via the interface section 12a based on the temperatures detected by the temperature sensors 31, 32, 33, . . . , 3n. In the second embodiment, the control section 17 has the following fourth and fifth control modes M4 and M5 as a function to prevent heat from concentrating into a specific part of the processor section 11.

When the fourth control mode M4 is applied, the control section 17 performs control of lowering the operation frequency of a processor, which has a temperature higher than the predetermined value, at every specified time.

When the fifth control mode M5 is applied, the control section 17 performs control of setting a processor, which has a temperature higher than the preset value, to execute a program having a lower load at every specified time.

The control section 17 applies either of the above control modes M4 and M5 suitably depending on the conditions, so that the heat generated in the chip can be uniform. Thus, the control prevents the processors from malfunctioning or breaking down due to heat.

As a modification of the above, the control modes M4 and M5 may be combined into one control mode. Alternatively, the control mode M4 or M5 may be performed fixedly, or selectively depending on operation conditions.

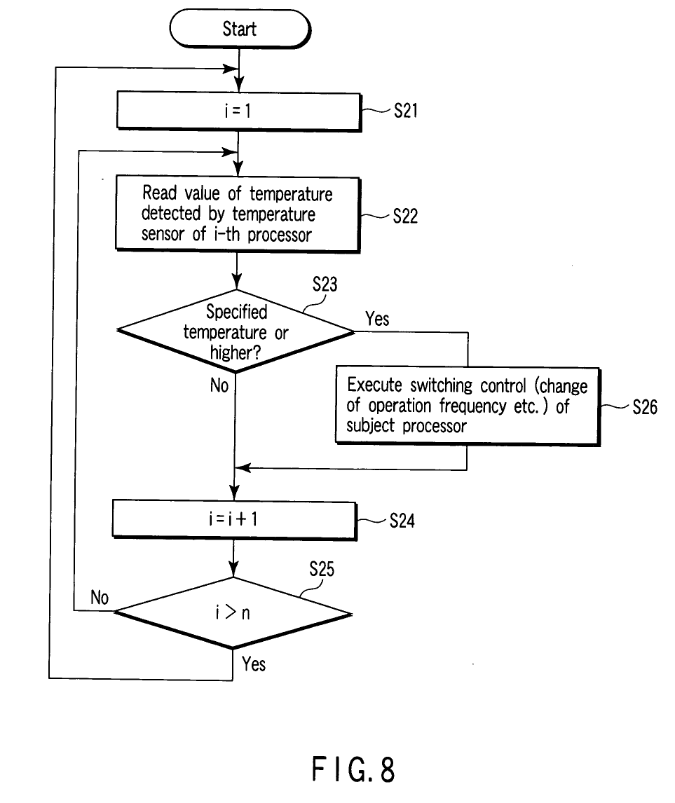

An operation of the controller 12 of this embodiment will be described with reference to the flowchart shown in FIG. 8.

In the following description, it is assumed that the processors 1, 2, 3, . . . , n are respectively executing given programs, and the control mode M4 or M5 is applied to the controller 12.

The controller 12 checks temperatures of the processors 1 to n at specified time intervals in the order of, for example, from the processor 1, 2, 3, . . . to n. More specifically, first of all, the controller 12 sets the first processor 1 as an i-th processor (i=1 to n), i.e., a subject processor to be checked (block S21). Then, the controller 12 reads the value of the temperature detected by the temperature sensor of the i-th processor (block S22), and determines whether the value exceeds a specified value of the temperature (or whether the value is equal to or greater than the specified value) (block S23).

If the controller 12 determines that the value of the temperature detected by the sensor does not exceed the specified value, the next processor in turn is subjected to the check (block S24). Then, the controller 12 determined whether check of the n-th processor has been completed or not (block S25). If not, the process from the blocks S22 to S25 is repeated. If completed, the process from block S21 to S25 is repeated.

In the above block S23, if the controller 12 determines that the value of the temperature detected by the sensor exceeds the specified value, it executes switching control (change of the operation frequency or the like) of the subject processor (block S26). Then, the controller proceeds to the process of the block S24.

In the block S26, if the control mode M4 is applied, the controller 12 performs control to set the operation frequency of the subject processor to be lower than those of the other processors for the specified period of time. If the control mode M5 is applied, the controller 12 performs control to cause the subject processor to execute a program having a load that is lower than those of the programs executed by the other processors for the specified period of time.

As described above, according to the second embodiment, either the control mode M4 or M5 is suitably selected and applied depending on the conditions, so that the heat generated in the chip can be uniform. The control prevents the processors from malfunctioning or breaking down due to heat. In addition, since the result of detecting a temperature in each processor is used to control the processor, it is possible to prevent a specific processor from heating up to a particularly high temperature.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A controller for use in a multiprocessor incorporating a plurality of processors on one chip, the controller comprising:
a communication section to perform communication with the plurality of processors; and
a control section to perform control of switching operation states of the plurality processors one by one at every specified time via the communication section.

2. The controller according to claim 1, wherein the control section performs control of stopping the plurality of processors one by one at every specified time.

3. The controller according to claim 1, wherein the control section performs control of lowering operation frequencies of the plurality of processors one by one to a value lower than those of other processors at every specified time.

4. The controller according to claim 1, wherein the control section performs control of setting the plurality of processors one by one at every specified time to execute a program having a load that is lower than those of programs executed by other processors.

5. A controller for use in a multiprocessor incorporating a plurality of processors on one chip, the controller comprising:
a plurality of temperature sensors to respectively detect temperatures of the plurality of processors;
a communication section to perform communication with the plurality of processors; and
a control section to perform control of switching an operation state of any of the plurality processors at every specified time via the communication section based on the temperatures detected by the plurality of temperature sensors.

6. The controller according to claim 5, wherein the control section performs control of lowering an operation frequency of a processor, which has a temperature higher than a predetermined value, at every specified time.

7. The controller according to claim 5, wherein the control section performs control of setting a processor, which has a temperature higher than a predetermined value, to execute a program having a load that is lower than a currently executed program at every specified time.

8. A multiprocessor control method of controlling a multiprocessor incorporating a plurality of processors on one chip, the method comprising:
performing communication between the plurality of processors and a predetermined device; and
performing control of switching operation states of the plurality processors one by one by the predetermined device at every specified time.

9. The multiprocessor control method according to claim 8, wherein the control includes control of stopping the plurality of processors one by one at every specified time by the predetermined device.

10. The multiprocessor control method according to claim 8, wherein the control includes control of lowering operation frequencies of the plurality of processors one by one to a value lower than those of other processors at every specified time by the predetermined device.

11. The multiprocessor control method according to claim 8, wherein the control includes control of setting the plurality of processors one by one at every specified time by the predetermined device to execute a program having a load that is lower than those of programs executed by other processors.

12. The multiprocessor control method according to claim 8, further comprising respectively detecting temperatures of the plurality of processors by a plurality of temperature sensors, wherein the control includes control of switching an operation state of any of the plurality processors at every specified time by the predetermined device based on the temperatures detected by the plurality of temperature sensors.
